(19) United States
(12) Patent Application Publication
(10) Pub. No.: US 2013/0184617 A1
(43) Pub. Date: Jul. 18, 2013

(54) MUSCLE STRENGTH TRAINING APPARATUS AND METHOD FOR MUSCLE STRENGTH TRAINING

(71) Applicant: Tomohiko Inaba, Nagano (JP)

(72) Inventor: Tomohiko Inaba, Nagano (JP)

(21) Appl. No.: 13/825,637

(22) PCT Filed: Sep. 17, 2011
(86) PCT No.: PCT/JP11/71288

§ 371 Date: Mar. 22, 2013

(30) Foreign Application Priority Data
Sep. 24, 2010 (JP) 2010-214577
Aug. 24, 2011 (JP) 2011-182859

(51) Int. Cl. A61H 1/00

(52) U.S. Cl. CPC A61H 1/00
USPC 601/33

(57) ABSTRACT

To provide a muscle strength training apparatus with a simple structure and low production cost and a muscle strength training method, wherein the apparatus and the method are capable of conducting muscle strength training that acts on both flexion and extension with load decreasing when the muscle is fatigued, and are safe without excessive force being applied on joints or muscles because no load is applied when movement is stopped.

[Solution] This muscle strength training apparatus is provided with a first fitted part (1) that is fitted along the femur of the user and a second fitted part (2) that is fitted along the lower leg of the user. The first fitted part (1) is pivotally attached to the second fitted part (2) by means of bolts (30a, 31a) and nuts (30b, 31b). The first fitted part (1) and the second fitted part (2) are connected via an oil damper (3). The oil damper (3) is disposed on the side opposite the side of lower leg flexion. Moreover, the center of the axis of the oil damper (3), the connection between the oil damper (3) and the first fitted part (1), and the connection between the oil damper (3) and the second fitted part (2) are disposed on the plane in which the lower leg bends.

### TECHNICAL FIELD

The present invention relates to a muscle strength training apparatus and a method for muscle strength training, which can effectively perform muscle strength training at a restricted site such as on a bed or at a bed side.

### BACKGROUND ARTS

Patients entering in a hospital due to an upper extremity or a lower upper extremity injury (for example, knee arthroplasty, and cruciform reconstructive surgery etc.) and patients who cannot move from a bed due to under medical treatment drastically decrease their muscle strengths. Consequently, they need muscle strength training, which can be performed under restricted conditions or at a restricted site, i.e., under the conditions that they are sitting on a chair or lying down on a bed.

Also, in the case of the elderly or physically handicapped persons, even when they are not in a hospital, it is often difficult for them to use general training apparatuses. For this reason, for the elderly or physically handicapped persons, apparatuses have been desired which can be used for effectively performing muscle strength training.

As muscle strength training methods, weight type or tension type muscle strength training methods have hitherto been known, but these methods can be performed at a supine position only with difficulty. Also, since the load is decided by a weight or a spring, these methods can regulate the load in a flexible manner depending upon the muscle strength only with difficulty. Also, since load is kept applied even after the operation is stopped, there is a risk especially in the elderly or physically handicapped persons.

Muscle training has been performed using manual resistance in which a third person, such as physical therapist, manually applies a load. However, it is difficult for this method to apply a certain load or adjust a load, and skills are required for effectively performing muscle strength training.

In addition, an apparatus for muscle training utilizing an oil damper in order to regulate a load in a flexible manner depending upon muscle strength has been developed (for example, Patent Document 1). Also, an apparatus for muscle strength training has been suggested which previously regulates a load on a muscle, and which applies resistance against the movement independent of a speed (Patent Document 2). According to this, the most preferably load pattern can be applied to the muscle in the muscle strength training by previous program.

However, these muscle strength training apparatuses disclosed in Patent Documents 1 and 2 are complicated and large scale apparatuses, leading to the increasing of their production cost. Also, these apparatuses can be used at the supine position only with difficulty.

### PRIOR ART DOCUMENTS

### Patent Documents

Patent Document 1: Japanese Patent Laid-Open Application No. 2006-296862.
Patent Document 2: Japanese Patent No. 3713046

### SUMMARY OF THE INVENTION

### Problems to be Solved by the Invention

The present invention has been accomplished in light of the conventional situations mentioned above, and the problem to be solved by the invention is to perform muscle strength training which can act both on bending and stretching extension even at the supine position and to provide a muscle strength training apparatus with a simple structure and low production cost.

### Means for Solving Problems

A muscle strength training apparatus according to the first aspect of the present invention is characterized in that one end of a first part and one end of a second part are movably supported by a bearing, and the first part and the second part are connected via an oil damper.

In the muscle strength training apparatus according to the first aspect of the present invention, since the first part and the second part are connected via an oil damper, when the user grips or fits the first part and the second part and bends or stretches the elbow joint or the knee joint whereby the parts are repeatedly rotated around the bearing, the oil damper is elongated and contracted. The resistance of the oil damper is increased as the rotation speed becomes is increased. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the muscle. Also, when the movement is stopped, no load is applied. Consequently, no undue force is applied to the joint and the muscle, the apparatus is considered to be high safety. Furthermore, the resistance of the oil damper acts both on bending and stretching, various muscles of upper extremity can be totally trained unlike the expander which only acts on tensile strength.

The term “oil damper” used herein is a relaxation equipment which can apply the resistance depending upon the speed utilizing the viscosity of fluid (including water, gas and the like in addition to an oil), and is also called “hydraulic cylinder”, or “dash pot”. The resistance of the oil damper becomes large as the speed of bending and stretching the first and the second parts is increased. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the muscle. Also, when the movement is stopped, no load is applied. Consequently, no undue force is applied to the joint and the muscle, the apparatus is considered to be high safety. Furthermore, the resistance of the oil damper acts both on bending and stretching, the muscle training can be performed both for bending and stretching.

In the second aspect of the present invention, the first part and the second part preferably make up a T-shape. In this shape, wide variety of exercises such as squat exercise can be performed in such a manner that the parts are repeatedly rotated around the bearing while griping the first part and the second part, or holding down the first part and the second part by the bottoms of the feet.

A muscle strength training apparatus according to the third aspect of the present invention is a muscle strength training apparatus wherein one end of a first part and one end of a second part are movably supported by a bearing, and the first part and the second part are connected via an oil damper, characterized in that the first part is fitted along a region extending to a body side of the user from the elbow joint or the knee joint and the second part is fitted along a region extending to the terminal side from the elbow joint or the knee joint of the user; the first part and the second part are axially attached in a bending manner not so as to inhibit the movement of the knee joint or the elbow joint, the oil damper is positioned opposite the side where the upper extremity or the lower extremity is bent and stretched, and the shaft center of the oil damper is positioned along the center line of upper extremity or the lower extremity in the width direction.

In the muscle strength training apparatus according to the third aspect of the present invention, the first part is fitted along a region extending to a body side of the user from the elbow joint or the knee joint (i.e., upper arm region or femur), and the second part is fitted along a region extending to the terminal side from the elbow joint or the knee joint of the user (i.e., forearm or upper leg region). Since the first part and the second part are axially attached in a bending manner not so as to inhibit the movement of the knee joint or the elbow joint, the user having the apparatus fitted can move the elbow joint or the knee joint. Since the first part and the second part are connected via the oil damper, the user must exhibit the force against the resistance of the oil damper, when the user bents or stretches the elbow joint or the knee joint. For this reason, the user can make training for improving the muscle strength by bending and stretching the elbow joint or the knee joint.

In the muscle strength training apparatus according to the third aspect of the present invention, since the oil damper is positioned opposite the side where the upper extremity or the lower extremity is bent and stretched, the oil damper is never obstructive to the training even when the upper extremity or the lower extremity are bent or stretched. Especially, in the case where the muscle strength training apparatus of the present invention is fitted to the lower extremity, the oil damper is not obstructive even in the state the user sits on a chair or lies on a bed while keeping the apparatus fitted.

In addition, since the shaft center of the oil damper is positioned along the center line of upper extremity or the lower extremity in the width direction (in other words, since the shaft center of the oil damper is not positioned at a biased position against the center line of upper extremity or the lower extremity in the width direction), no undue force such that the muscle strength training apparatus and upper and lower extremities are twisted is acted.

Consequently, according to the muscle strength training apparatus according to the third aspect of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

In the muscle strength training apparatus according to the fourth aspect of the present invention, the resistance value of the oil damper is configured to be adjustable in according to the third aspect of the present invention. In this configuration, an adequate load can be applied to the muscle depending upon the muscle strength of the user.

In the muscle strength training apparatus according to the fifth aspect of the present invention, the oil damper is placed along the second part in the muscle strength training apparatus according to the third or the fourth aspect of the present invention. Since the second part is positioned far from the body, the oil damper interferes muscle training only with difficulty.

In the muscle strength training apparatus according to the sixth aspect of the present invention, the first part is applied along a region of the user from the ankle to the shin, the second part is applied along the bottom of the foot, the first part and the second part are axially attached in a bendable manner not so as to inhibit bending and stretching movement of the ankle joint, the oil damper is placed at the side where the ankle is bent and stretched, and the shaft center of the oil damper is placed along the center line of the calf in the width direction in the muscle strength training apparatus according to the first aspect of the present invention.

In the muscle strength training apparatus according to the sixth aspect of the present invention, the first part is applied along a region of the user from the ankle to the shin, and the second part is applied along the bottom of the foot. Since the first part and the second part are axially attached in a bendable manner not so as to inhibit bending and stretching movement of the ankle joint, and since the first part and the second part are connected via the oil damper so that the user having the apparatus applied can perform the bending and stretching movement of the ankle joint, the user must exhibit a force against the resistance of the oil damper when the user bents or stretches the ankle joint. For this reason, the user can perform training for improving muscle strength of the triceps surae muscle and the muscle strength of tibialis anterior muscle at the same time.

The resistance of the oil damper becomes large as the speed of bending and stretching the first part and the second part becomes rapid. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the joint and the muscle. Also, when the movement is stopped, no load is applied. Consequently, no undue force is applied to the joint and the muscle, the apparatus is considered to be high safety. Furthermore, the resistance of the oil damper acts both on bending and stretching, the apparatus can perform muscle strength training both for bending and stretching.

Since the shaft center of the oil damper is placed along the center line of the calf in the width direction (in other words, since the shaft center of the oil damper is not positioned at a biased position from the center line of the calf in the width direction), no undue force such that the muscle strength training apparatus and upper and lower extremities are twisted is acted.

Consequently, according to the muscle strength training apparatus according to the sixth aspect of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

In the muscle strength training apparatus, the damper is preferably placed along the first part, because the oil damper interferes muscle training only with difficulty.

In the muscle strength training apparatus according to the seventh aspect of the present invention, the muscle strength training apparatus is the apparatus for training both the right and left lower extremities at the same time. The apparatus possesses a pair of the first parts applied to portions extending to a body side of the user from the both knee joints, and a pair of the second parts applied to portions extending to the terminal side from the both knee joints of the user. These first parts and the second parts are axially attached in a bending manner not so as to inhibit the movement of the knee joint. The both first parts are connected by a first connector and the both second parts are connected by a second connector. The first connector and the second connector are connected via the oil damper.

The muscle strength training apparatus according to the seventh aspect of the present invention possesses a pair of the first parts applied to portions extending to a body side of the user from the both knee joint, and a pair of the second parts applied to portions extending to the terminal side from the both knee joints of the user and these first parts and the second parts are axially attached in a bending manner not so as to inhibit the movement of the knee joints.

Accordingly, the user having the apparatus applied can move the apparatus in such a manner that both knee joints can be bent and stretched. Also, in this apparatus, the both first parts are connected together with the first connector and the both second parts are connected together with the second connector, and the first connector and the second connector are connected via the oil damper and, thus, the user must exhibit the force against the resistance of the oil damper when the user bends or stretches the both knee joints. For this reason, the user can perform training for improving muscle strength of the both lower extremities at the same time.

The resistance of the oil damper becomes large as the speed of bending and stretching the first part and the second part becomes rapid. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the muscle. Also, when the movement is stopped, no load is applied. Consequently, no undue force is applied to the joint and the muscle, the apparatus is considered to be high safety. Furthermore, since the resistance of the oil damper acts both on bending and stretching, the apparatus can perform muscle strength training in both cases.

Consequently, according to the muscle strength training apparatus according to the seventh aspect of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

In the muscle strength training apparatus according to the eighth aspect of the present invention, the muscle strength training apparatus is an apparatus for training both the right and left lower extremities at the same time. The apparatus possesses a pair of the first parts applied to portions extending to a body side of the user from the both knee joints, and a pair of the second parts applied to portions extending to the tip side from the both ankles of the user. These first parts and the second parts are axially attached in a bending manner not so as to inhibit the movement of the knee joints. The both first parts are connected by a first connector and the both second parts are connected by a second connector. The first connector and the second connector are connected via the oil damper.

The muscle strength training apparatus according to the eighth aspect of the present invention, the both first parts are connected together with the first connector and the both second parts are connected together with the second connector, and the first connector and the second connector are connected via the oil damper and, thus, the user must exhibit the force against the resistance of the oil damper when the user bends or stretches both knee joints. For this reason, the user can perform training for improving muscle strength of both lower extremities at the same time.

The resistance of the oil damper becomes large as the speed of bending and stretching the first part and the second part becomes rapid. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the muscle. Also, when the movement is stopped, no load is applied. Consequently, no undue force is applied to the joint and the muscle, the apparatus is considered to be high safety. Furthermore, since the resistance of the oil damper acts both on bending and stretching, the apparatus can perform muscle strength training in both cases.

Consequently, according to the muscle strength training apparatus according to the eighth aspect of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

In the muscle strength training apparatus according to the ninth aspect of the present invention, the muscle strength training apparatus is an apparatus for training both the right and left lower extremities at the same time, having a first fitted part applied along a portion extending to a body side of the user from the both knee joints, a second fitted part applied along a portion extending to the terminal side from the both knee joints of the user, a third fitted part applied to the bottom of the foot of the user.

The first fitted part and the second fitted part are axially attached in a bending manner not so as to inhibit the movement of the knee joint. The second fitted part and the third fitted part are axially attached in a bending manner not so as to inhibit the up-and-down movement of the toe. The first fitted part and the third are connected via the oil damper. The oil damper is placed at the side opposite the side where the lower extremity is bent and stretched, and the shaft center of the oil damper is placed along the center line of the lower extremity in the width direction.

In the muscle strength training apparatus according to the ninth aspect of the present invention, the first fitted part applied along a portion (i.e., femoral region) extending to a body side of the user from the both knee joints, the second fitted part applied along a portion (i.e., leg region) extending to the terminal side from the both knee joints of the user, and the third fitted part applied to the bottom of the foot of the user. Since the first fitted part and the second fitted part are axially attached in a bending manner not so as to inhibit the movement of bending and stretching the knee joints, the user having the apparatus applied can perform bending and stretching movement of the knee joints.

Since the second fitted part and the third fitted part are axially attached in a bending manner not so as to inhibit the movement of bending and stretching the ankle joints, the user having the apparatus applied can perform bending and stretching movement of the ankle joints.

Since the first fitted part and the third fitted part are connected via the oil damper, the user must exhibit the force against the resistance of the oil damper when the user bends and stretches the knee joint or the ankle joint. Consequently, the user can perform the muscle strength training of the femoral region and the muscle strength training of the leg region at the same time by one apparatus for muscle strength training.

The resistance of the oil damper becomes large as the speed of bending and stretching the knee joints or that of bending and stretching the ankle joints becomes rapid. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the muscle. Also, when the movement is stopped, no load is applied. Consequently, no undue force is applied to the joint and the muscle, the apparatus is considered to be high safety. Furthermore, since the resistance of the oil damper acts both on bending and stretching, the apparatus can perform muscle strength training in both cases.

In addition, since the shaft center of the oil damper is positioned along the center line of the calf in the width direction (in other words, since the shaft center of the oil damper is not positioned at a biased position against the center line of the calf), no undue force such that the muscle strength training apparatus and upper and lower extremities are twisted is acted.

As described above, the muscle strength training apparatus according to the first to ninth aspect of the present invention is be used, and the oil damper is bended and extracted, whereby various muscle strength of the upper extremity and the lower extremity can be improved.

In the muscle strength training apparatus according to the first to ninth aspect of the present invention, the resistance value of the oil damper is preferably adjustable, because an adequate load can be applied to the muscle depending on the muscle strength of the user.

### DESCRIPTION OF SYMBOLS

1, 41, 71, 101, 201, . . . First fitted part (first part)
2, 42, 72, 102, 202, 150, 250 . . . Second fitted part (second part)
73, . . . Third fitted part
3, 43, 74, 203, . . . Oil damper
20a, 22a, 31a, 54a, 55a, 84a, 88a, 130a, 131a, . . . Bolt
31b,54b,55b,84b,88b,130b,131b, . . . Nut 3c, 8a, 43c, 74c, . . . Annular part
240, . . . Saddle part (First connecter)
241, . . . Saddle part (Second connector)
303, . . . Bearing
301, 401, 501, 601, . . . First Lever (First part)
302, 402, 502, 602, . . . Second Lever (Second Part)

### EMBODIMENTS FOR CARRYING OUT INVENTION

The examples which realize the present invention will now be described in detail.

### Example 1

The muscle strength training apparatus of Example 1 is applied to a lower extremity to perform muscle strength training of lower extremity muscle strength. As shown in FIG. 1, the apparatus possesses a first fitted part 1 to be fitted along a femoral region of the user, a second fitted part 2 to be fitted along a shin region of the user and an oil damper 3.

As shown in FIG. 2, the first fitted part is composed so that two parallel elongate board parts 4 and 5, a saddle part 6, which connects the elongate board parts 4 and 5, a saddle part 7 which connects the elongate board parts 4 and 5 at a central position somewhat near the knee side, and a knee part 8 projected toward an oblique direction at one end of the knee side, which connects the elongate board parts 4 and 5, are fixed by bolts and nuts. It is also possible to fix or unify them by caulking, rivets, or welding instead of the bolts and nuts. Felts 9, 10, and 11 for protecting the femoral region and the knee region are applied on the rear sides of saddle parts 6 and 7 and knee part 8. Also, to the insides of the felts 9, 10, and 11 are attached surface fasteners 12a, 12b, 13a and 13b for fitting the first fitted part 1 to the femoral region.

Elongate board parts 14, 15 facing each other elongated toward the leg region at the time of application, and an ankle part 16 which connects the elongate board parts 14 and 15 at one end of the ankle region are fixed to the second fitted parts by bolts and nuts. A felt 17 for protecting the ankle is applied on the rear side of the ankle region 16. Also, surface fasteners 18a, and 18b for fitting the second fitted part 2 are attached to the inside of the felt 17.

The first fitted part 1 and the second fitted part 2 are connected in a bendable manner at one end of the knee sides of the elongate board parts 4 and 5 and the elongate board parts 14 and 15 by bolts 30a and 31a and nuts 30b and 31b.

The oil damper 3 has a configuration that a shaft 3b is inserted into a cylinder 3a, and an annular part 3c is placed on the shaft 3b at one end of the ankle side. While the shaft 3b is configured to project from both sides of the cylinder 3a in this example, such a type of an oil damper that the shaft is only projected from one side in the lengthwise direction may be used instead. A piston (not shown), having the same shaft center as that of the cylinder 3a, is installed within the cylinder 3a in a reciprocating manner. A force to meet the movement speed of the piston is required for the movement of the piston in order to contract the viscosity of the oil incorporated within the cylinder 3a. As for the fore required for moving the piston, by the diameter of the pathway of the oil moving within the cylinder 3a is changed by rotating the tip of the shaft 3b, whereby the resistance may be adjusted.

L-shaped clasps 19a and 19b stand facing each other at a several gap at the back of the ankle part 16 as shown in FIG. 2. The annular part 3c is inserted into the gap between the L-shaped clasps 19a and 19b. A bolt 20c is inserted passing through the L-shaped clasps 19a and 19b and the annular part 3c, and is fixed onto a nut 20c. This makes it possible to rotate the shaft 2b around the bolt 20a. A caulking part 21 for fitting is wound around one end of the cylinder 3a at the knee side, and the caulking part 21 has a projection part 21a projected downward. An annular part 8a is placed on the back of the knee part 8 at the top side, a screw 22a is inserted passing through the projection part 21a and the annular part 8a and fastened by the nut 22b. This makes it possible to rotate the cylinder 3a around the bolt 22a.

### <How to Use>

Next, how to use the muscle strength training apparatus of Example 1 configured as described above will be described.

### Attaching Method

First of all, the user fits the first fitted part 1 on the femoral region by means of the surface fasteners 12a, 12b, 13a, and 13b, and further fits the second fitted part 2 on the shin region by means of the surface fasteners 18a and 18b. The fitting of the apparatus may be carried out under the situation that the user sits down in a chair or lies down on a bed.

### Training Method

The user, who has fitted the muscle strength training apparatus of Example 1, put some muscle in the direction from the sitting situation to the situation of stretching the knee. As shown in FIG. 4 and FIG. 5, by this movement, the first fitted part 1 and the second fitted part 2 extend around the bolt 31a. Since the oil damper 3 is positioned opposite the direction where the knee joint extends, it does not obstruct the bending and stretching the knee joint of the user. Also, since the shaft center of the oil damper 3 is positioned along the center line of the lower extremity in the width direction (X-X in FIG. 2), no undue force such that the muscle strength training apparatus and upper and lower extremities are twisted is acted. Also, the resistance of the oil damper 3 is increased as the speed of bending and stretching the first fitted part and the second fitted part, and when exertion muscle strength is decreased due to muscle fatigue, the resistance is decreased accordingly. (For this reason, the training can be continued even during the course of fatigue). Furthermore, the resistance of the oil damper acts both on bending and stretching, various muscles of upper extremity can be trained in both cases.

Consequently, according to the muscle strength training apparatus according to the of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

Whereas training method at the seated position, the training can similarly be performed on the bed at the face-up position. In this case, unlike the training at the seated position, in the case of the training at the face-up position, the bending and stretching of the hip joint can be performed at the same time.

The muscle strength training apparatus of Example 1 is a type of the apparatus to be fitted to the lower extremity, the apparatus for upper extremity muscle strength training can be realized if the parts are formed so that they can be fitted to meet the upper extremity.

It can be considered to form a muscle strength training apparatus using a spring instead of the oil damper in Example 1. However, since the load is decided by the length of stretching the spring in the case of the spring, the load cannot be flexibly adjusted depending on the muscle strength. Also, even when the operation is stopped, the load is applied if the spring is under the stretching state, there is a risk for the elderly and persons who is under medical treatment.

### Example 2

The muscle strength training apparatus of Example 2 is applied to a lower extremity (specifically triceps surae muscle and tibialis anterior muscle) to perform muscle strength training of lower extremity muscle strength. As shown in FIG. 3, the apparatus possesses a first fitted part 41 to be fitted along a portion of the user from the ankle to the upper portion, a second fitted part 42 fitted along the bottom of the foot of the user and an oil damper 43 as shown in FIG. 6.

As shown in FIG. 8, the first fitted part 41 is composed so that parallel elongate board parts 44 and 45 and saddle part 46 fixed by means of bolts and nuts similar to the muscle strength training apparatus of Example 1. It is also possible to fix or unify them by caulking, rivets, or welding instead of the bolts and nuts. A felt 47 is applied on the rear side of saddle part 46. Also, to the insides of the felt 47 are attached surface fasteners 48a, and 48b for fitting the first fitted part 41 to the calf region.

An elongate board part 49 elongated toward the bottom of the foot, a saddle part 50 for fixing the elongate board part 49 along the bottom of the foot at the toe, and elongate board parts 51, 52 facing each other at portions near the terminal of the elongate board part 49 are placed on the second fitted part 42. Felts 53,62a and 62b are placed on the rear sides of saddle part 50 and the elongate board parts 51 and 52.

The first fitted part 41 and the second fitted part 42 are connected in a bendable manner at one ends of the ankle sides of the elongate board parts 51 and 52 by bolts 54a and 55a and nuts 54b and 55b.

The oil damper 43 has the same configuration as that of the oil damper 3 in Example 1, and a cylinder 43a, a shaft 43b and an annular part 43c are placed thereon.

L-shaped clasps 56a and 56b stand facing each other at a several gap at the back of the saddle part 50. The annular part 43c is inserted into the gap between the L-shaped clasps 56a and 56b. A bolt 57c is inserted passing through the L-shaped clasps 56a and 56b and the annular part 43c, and is fixed onto a nut 57c. This makes it possible to rotate the shaft 43b around the bolt 57a. A caulking part 58a for fitting is wound around one end of the cylinder 43a at one side of the knee region, and the caulking part 58a has a projection part 58b projected downward as shown in FIG. 6 and FIG. 7. An annular part 59 is placed on the back of the saddle part 46 at the top portion, a screw 60a is inserted passing through the projection part 58b and the annular part 59, and fastened by the nut 60b. This makes it possible to rotate the cylinder 43a around the bolt 57a.

### <How to Use>

Next, how to use the muscle strength training apparatus of Example 2 configured as described above will be described.

### Attaching Method

First of all, the user inserts the second fitted part 42 on the toe of the foot to be trained into the saddle part 50 as shown in FIG. 6. Subsequently, the first fitted part is fitted to the calf region by using the surface fasteners 48a and 48b of the first fitted part. The fitting of the apparatus may be carried out under the situation that the user sits down in a chair or lies down on a bed.

### Training Method

The user, who has fitted the muscle strength training apparatus of Example 2, performs bending and stretching exercises of the ankle. As shown in FIG. 6 and FIG. 7, by this movement, the first fitted part 41 and the second fitted part 42 extend around the bolt 54a. Since the shaft center of the oil damper 43 is positioned along the center line of the calf region in the width direction (Y-Y in FIG. 8), no undue force such that the muscle strength training apparatus and upper and lower extremities are twisted is acted. Also, the resistance of the oil damper 43 is increased as the speed of bending and stretching, and when exertion muscle strength is decreased due to muscle fatigue, the resistance is decreased accordingly as described previously in Example 1. For this reason, no excessive load is applied at the time of muscle fatigue. Furthermore, the resistance of the oil damper acts both on bending and stretching, the muscle strength training for the tibialis anterior muscle can be performed at the time of bending, and the muscle strength training for the triceps surae muscle can be performed at the time of stretching.

As described above, according to the muscle strength training apparatus of Example 2, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

### Example 3

The muscle strength training apparatus of Example 3 can train both the muscles of the femoral region and those of the leg region at the same time and has a configuration of Example 1 in combination with Example 2.

Specifically, as shown in FIG. 9, the apparatus is composed of a first fitted part 71 fitted along the region extending to a body side of the user from the knee joint (specifically femoral region), a second fitted part 72 fitted along the region extending to the terminal side from the knee joint (specifically leg region) of the user, a third fitted part 73 fitted along the bottom of the foot of the user, and an oil damper 74.

In the first fitted part 71, an elongate board part 75, a saddle part 76 which connects the elongate board part 75 at one side, a saddle part 77 which connects the elongate board part 71 at a central position somewhat near the knee side, and a knee part 78 projected toward an oblique direction at one end of the knee side, which connects the elongate board part 71 are fixed by bolts and nuts. It is also possible to fix or unify them by caulking, rivets, or welding instead of the bolts and nuts. Felts 79, 80, and 81 for protecting the femoral region and the knee are applied on the rear sides of saddle parts 76 and 77 and knee part 78. Also, to the insides of the felts 9, 10, and 11 are attached surface fasteners 82a, 82b, 83a and 83b for fitting the first fitted part 71 to the femoral region.

An elongate board part 72a is placed on the second fitted part 72. The first fitted part 71 and the second fitted part 72 are connected in a bendable manner at one ends of the ankle side of the elongate board part 75 and the elongate board 72a by a bolt 84a and a nut 84b.

An elongate board part 85 elongated toward the bottom of the foot, a saddle part 86 for fixing the elongate board part 85 along the bottom of the foot at the toe, and an elongate board part 87 placed at a portion near the terminal of the elongate board part 85 are placed on the third fitted part 73. Felts 88 and 89 are placed on the rear sides of saddle part 86 and the elongate board part 87. An annular surface fastener 95 is stitched onto the felt 88 in order to attach the toe to third fitted part 73.

The second fitted part 72 and the third fitted part 73 are connected in a bendable manner at one ends of the ankle sides of the elongate board parts 72a and 87 by a bolt 88a and a nut 88b. The oil damper 74 has the same configuration as that of the oil damper 3 in Example 1, and a cylinder 74a, a shaft 74b and an annular part 74c are placed thereon.

L-shaped clasps 89a and 89b stand facing each other at a several gap at the back of the saddle part 86 similar to Example 1 and Example 2. The annular part 74c is inserted into the gap between the L-shaped clasps 89a and 89b. A bolt 91a is inserted passing through the L-shaped clasps 89a and 89b and the annular part 74c, and is fixed onto a nut 91b. This makes it possible to rotate the shaft 74b around the bolt 91a. A caulking part 92a for fitting is wound around one end of the cylinder 74a at one side of the knee region, and the caulking part 92a has a projection part 92b projected downward. An annular part 93 is placed on the back of the saddle part 81 at the top side, a screw 94a is inserted passing through the projection part 92b and the annular part 93 and fastened by the nut 94b. This makes it possible to rotate the cylinder 74a around the bolt 94a.

### <How to Use>

Next, how to use the muscle strength training apparatus of Example 3 configured as described above will be described.

### Attaching Method

First of all, the user inserts the toe into the surface fastener 95 and further into the saddle part 86 as shown in FIG. 9. Subsequently, the first fitted part is fitted to the femoral region by using the surface fasteners 83a, 83b, 82s and 82b of the first fitted part. The fitting of the apparatus may be carried out under the situation that the user sits down in a chair or lies down on a bed.

### Training Method

The user who has fitted the muscle strength training apparatus of Example 3 performs bending and stretching exercises of the ankle under the situation that the user sits down in a chair or lies down on a bed. By this movement, the distance between the bolts 91a and 94a serving as the bearing in FIG. 9 is changed and the load of the oil damper 74 applies a load on various muscles of lower extremity, whereby the muscle strength training for the femoral region and the muscle strength training for the leg region can be performed at the same time. Since the oil damper 74 is positioned opposite the direction where the knee joint bends, it does not obstruct the bending and stretching the knee joint of the user. Also, since the shaft center of the oil damper 73 is positioned along the center line of the lower extremity in the width direction, no undue force such that the muscle strength training apparatus and upper and lower extremities are twisted is acted. Also, the resistance of the oil damper 74 is increased as the speed of bending and stretching the knee and the ankle, and when exertion muscle strength is decreased due to muscle fatigue, the resistance is decreased accordingly. For this reason, no excessive load is applied at the time of muscle fatigue and is considered to be safety. Furthermore, the resistance of the oil damper acts both on bending and stretching, the muscle strength training can be performed in both cases.

Consequently, according to the muscle strength training apparatus of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

As described above, according to the muscle strength training apparatus of Example 3, the muscle strength training for the femoral region and the muscle strength training for the leg region can be performed at the same time under the situation that the user sits down in a chair or lies down on a bed. Also, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost.

### Example 4

The muscle strength training apparatus of Example 4 is a variant of the muscle strength training apparatus of Example 1 composed of a pair of fitted parts to be fitted to both feet equipped with an oil damper, and is to be trained for both lower extremities at the same time.

Specifically, as shown in FIG. 10, the apparatus possesses a pair of first fitted parts 101 and 201 fitted along the both femoral regions of the user, and a pair of second fitted parts 102 and 202 fitted along both shin regions of the user.

In first fitted parts 101 and 201, two parallel elongate board parts 104 and 105, and elongate parts 204 and 205, saddle part 106, which connects the elongate board parts 104 and 105, a saddle part 206 which connects the elongate board parts 204 and 205, a saddle part 207, which connects the elongate board parts 104 and 105 and the elongate board parts 204 and 205 at a central position somewhat near the knee side, and knee parts 108 and 208 projected toward an oblique direction at one end of the knee side, which connects the elongate board parts 104 and 105, and the elongate board parts 204 and 205 are fixed by bolts and nuts. It is also possible to fix or unify them by caulking, rivets, or welding instead of the bolts and nuts. Felts 109, 110, and felts 111 and 209, 210, and 211 for protecting the femoral region and the knee region applied on the rear sides of the saddle parts 106 and 107 and the saddle parts 206 and 207. Also, to the insides of the felts 109, 110, 209 and 211 are attached surface fasteners 112a, 112b, 113a 113b, 212a, 212b, 213a and 213b for fitting the first fitted parts 101 and 201 to the femoral region.

Elongate board parts 114, 115 facing each other elongated toward the leg region at the time of application, ankle part 116 which connects the elongate board parts 114 and 115 at one end of the ankle region, ankle part 216 which connects the elongate board parts 214 and 215 at one end of the ankle region are fixed to the second fitted parts 102 and 202 by bots and nuts. Felt 117 and 217 for protecting the ankle are applied on the rear side of the ankle regions 116 and 216. Also, surface fasteners 118a, 118b, 218a and 218b for fitting the second fitted part 2 are attached to the inside of the felts 117, and 217.

The first fitted part 101 and the second fitted part 102 are connected in a bendable manner at one end of the knee sides of the elongate board parts 104 and 105 and the elongate board parts 114 and 115 by bolts 130a and 131a and nuts 130b and 131b. Similarly, the first fitted part 201 and the second fitted part 202 are connected in a bendable manner at one end of the knee sides of the elongate board parts 204 and 205 and the elongate board parts 214 and 215 by bolts 230a and 231a and nuts 230b and 231b.

On the top of the saddle part 108, one end of an arch-like saddle part 240 is welded, and the other end of the arch-like saddle part 240 is welded at the top of the saddle part 208, to thereby connect the first fitted part 101 and the first fitted part 201 with each other. In this case, the arch-like saddle part 240 is the first connecter. Furthermore, on the top of the ankle part 116, one end of an arch-like saddle part 241 is welded, and the other end of the arch-like saddle part 241 is welded at the top of the ankle part 216, to thereby connect the second fitted part 102 and the second fitted part 202 with each other. In this case, the arch-like saddle part 241 is the second connecter.

On the top of the saddle part 240 and on the top of the saddle part 241, the oil damper 203 of Example 1 is fixed. Since the configuration and the attaching method of the oil damper 240 are the same as those of Example 1, the same symbols are assigned to the same parts and the details are omitted.

### <How to Use>

Next, how to use the muscle strength training apparatus of Example 4 configured as described above will be described.

### Attaching Method

First of all, the user fits the first fitted parts 101 and 201 on the femoral regions of both feet by means of the surface fasteners 112a, 112b, 113a, 113b, 212a, 212b, 213a, and 213b, and further fits the second fitted parts 2 on the shin regions by means of the surface fasteners 118a, 118b, 218a and 218b.

### Training Method

The user, who has fitted the muscle strength training apparatus of Example 4, puts some muscle in the direction from the sitting situation to the situation of stretching the knee. By this movement, the first fitted parts 101 and 201 and the second fitted parts 102 and 202 extend around the bolts 130a, 131a, 230a, 231a. Since the oil damper 203 is positioned opposite the direction where the knee joint bends, it does not obstruct the bending and stretching the knee joint of the user. Also, the resistance of the oil damper 203 is increased as the speed of bending and stretching the first fitted parts 101 and 201 and the second fitted parts 102 and 202, and when exertion muscle strength is decreased due to muscle fatigue, the resistance is decreased accordingly. (For this reason, the training can be continued even during the course of fatigue). Furthermore, the resistance of the oil damper 203 acts both on bending and stretching, the muscle strength training can be performed in both ways. Also, since the apparatus is fitted to both feet, the training for muscle strength of both feet can be performed on a uniform load at the same time.

Consequently, according to the muscle strength training apparatus according to the of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost. Also, since the apparatus is fitted to both feet, the training for muscle strength of both feet can be performed on a uniform load at the same time.

### Example 5

The muscle strength training apparatus of Example 5 is a variant of the muscle strength training apparatus of Example 4 and possesses second fitted parts 150 and 250 fitted on both toes as shown in FIG. 11, instead of the second fitted parts 102 and 202 (see FIG. 10).

Specifically, the second fitted parts 150 and 250 are composed so that felts 152 and 252 are applied on insides of stainless-made metal rings 151 and 251 by means of adhesive. On the top of the metal ring 151, one end of an arch-like saddle part 253 is welded, and the other end of the arch-like saddle part 253 is welded on the top of the metal ring 252, to thereby connect the second fitted part 150 and the second first fitted part 250 with each other via the saddle part 253. In this case, the saddle part 253 is the second connecter.

On the top of the saddle part 254 is fixed an oil damper 254. Since the configuration and the attaching method of the oil damper 254 are the same as those of Example 1, the same symbols are assigned to the same parts and the details are omitted.

### <How to Use>

Next, how to use the muscle strength training apparatus of Example 5 configured as described above will be described.

### Attaching Method

First of all, under the situation that the user lies down on a bed (or sits down in a chair), the user fits the first fitted parts 101 and 201 on the femoral regions of both feet using the surface fasteners 112a, 112b, 113a, 113b, 212a, 212b, 213a, and 213b. Subsequently, after the shaft 3b of the oil damper 254 is drawn out of the cylinder 3a, both toes are inserted into the felt 152 and the felt 252.

### Training Method

The user, who has fitted the muscle strength training apparatus of Example 5, puts some muscle in the direction to bending the knees. The shaft 3b moves within the cylinder 3a of the oil damper 254. By this movement, the resistance of the oil damper 254 is generated. When the bent knee is stretched, the shaft 3b moves within the cylinder 3a of the oil damper 254. By this movement, the resistance of the oil damper 254 is generated. The resistance of the oil damper 254 acts both on bending and stretching, the muscle strength training can be performed in both ways. Also, since the apparatus is fitted to both feet, the training for muscle strength of both feet can be performed on a uniform load at the same time.

Consequently, according to the muscle strength training apparatus according to the of the present invention, when an exertion muscle force due to the muscle fatigue the load is decreased accordingly, and when the operation is stopped, no load is applied and, thus, the apparatus is of very high safety, can perform muscle strength training which acts both on bending and stretching, and has a simple structure, leading to a low production cost. Also, since the apparatus is fitted to both feet, the training for muscle strength of both feet can be performed on a uniform load at the same time.

### Example 6

In the muscle strength training apparatus of Example 6, as shown in FIG. 12 and FIG. 13, one end of a first lever 301 and one end of a second lever 302 both composed of aluminum alloy made long board parts are axially supported by a bearing 303 in a rotatable manner, the other end of the first lever 301 and the other end of the second lever 302 are covered with rubber made grips 304 and 305. On a center position of the first lever 301 somewhat near the side of grip 304, a convex fitting part 306 is placed projected from the first lever 301 toward the inside, and one end of an oil damper 307 is rotatably attached by means of a screw 308 and a nut 309. On a center position of the second lever 302 somewhat near the side of bearing 303, a convex fitting part 310 is placed projected from the second lever 3012 toward the inside, and the other end of the oil damper 307 is rotatably attached by means of a screw 311 and a nut 312. The oil damper possesses a cylinder 307a and a shaft 307b.

In the muscle strength training apparatus of Example 6 configured as described above, by holding the grips 304 and 305 in the user's hand and repeating the rotation of them around the bearing 303, the oil damper 307 is bended and stretched. The resistance of the oil damper 307 is increased as the rotation speed is increased. Consequently, an adequate load can be applied to the muscle depending on the muscle strength of the user. When exertion muscle strength is decreased due to muscle fatigue, the resistance is decreased accordingly, and, therefore, the apparatus is safety because no excessive load is applied on the muscle. Furthermore, the resistance of the oil damper 307 acts both on bending and stretching, various muscles of upper extremity can be totally trained unlike the bender which only acts on tensile strength.

As a first variant of the muscle strength training apparatus of Example 6, on one end of the first lever 301 and on one end of the second lever 302, hafts 313 and 314 may be fixed substantially perpendicular to the levers as shown in FIG. 14 instead of the grips 304 and 305. In this case, the user holds the haft 313 of the first lever 301 on both hands, and steps the haft 314 of the second lever 302 the foot to be fixed to carry out squat exercise by repeating the rotation around the bearing 303. This makes it possible to perform various training including not only training for the muscle of upper extremity but also training for the muscle of lower extremity.

As a second variant of the muscle strength training apparatus of Example 6, on one end of the first lever 301 and on one end of the second lever 302, hafts 313 and 314 may be fixed substantially perpendicular to the levers, and annular parts 315 and 316 into which toes can be inserted may be placed on the haft 314 as shown in FIG. 15 instead of the grips 304 and 305. In this case, in addition to the squat exercise as in the first Variant, boating exercise in the seated position can be performed, because the easy fixation of both toes to the second lever.

### Example 7

In the muscle strength training apparatus of Example 7, a fitting part 420 is bolted on one end of a first lever 401 composed of an aluminum alloy long tubular part in such a manner that the fitting part 420 is projected from the first lever 401 in a dogleg form, and the fitting part 420 and one end of a second lever 420 is rotatably supported around a bearing 430. Grips 404 and 405 are fitted to the other end of the first lever 401 and the other end of the second lever 420 perpendicular to the levers to form a T-shape. A convex fitting part 406 is placed on substantially the center of the second lever 402 in such a manner that the convex fitting part 406 is projected outward from the second lever 402. One end of an oil damper 407 is rotatably attached to the convex fitting part 406 by a screw 408 and a nut 409, and the other end of the oil damper 407 is rotatably attached to the fitting part 420 by a screw 411 and a nut 412. The oil damper 407 possesses a cylinder 407a and a shaft 407b.

In the muscle strength training apparatus of Example 7 configured as described above, since the oil damper 407 is fitted opposite the user relative to the first lever 401 and the second lever 402, the apparatus obstructs the exercise only with difficulty. Similar to Variant 1 and Variant 2 of Example 6, the apparatus can be used for various exercises (see FIG. 17), and similar effects can be obtained by the exercises.

### Example 8

In the muscle strength training apparatus of Example 8, as shown in FIG. 18, one end of a first lever 501 and one end of a second lever 502 are axially attached to a rotary damper 507 in a rotatable manner while acting a braking force with the viscosity resistance. Grips 504 and 505 are fitted to the other end of the first lever 501 and the other end of the second lever 502 perpendicular to the levers in a T-shape.

In the muscle strength training apparatus of Example 8 configured as described above, since the cylindrical rotary damper 507 is used instead of the long oil damper, there is a merit that the damper difficultly obstructs the exercise when performing muscle strength training.

### Example 9

In the muscle strength training apparatus of Example 9, as shown in FIG. 19, an oil damper 607 is inserted within a first lever 601. The tip of a shaft 607b of the oil damper 607 is rotatably supported by the tip of a second lever 602 via a bearing 608. Near the tip of the second lever 602, one end of a ring part 610 is rotatably supported via a bearing 608, and the other end of the ring part 610 is rotatably supported near the tip of the first lever 601 via a bearing 611. One end of a first lever 501 and one end of a second lever 502 are axially attached to a rotary damper 507 in a rotatable manner while acting a braking force with the viscosity resistance. Grips 504 and 505 are fitted to the other end of the first lever 501 and the other end of the second lever 502 perpendicular to the levers in a T-shape. On one ends of the first lever 601 and second lever 602 at a side opposite the bearing 608, grips 604 and 605 are attached perpendicular to the lever in a T-shape.

In the muscle strength training apparatus of Example 9 configured as described above, since the oil damper 607 is inserted within the first lever 601, there is a merit that the damper difficultly obstructs the exercise when performing muscle strength training.

In the muscle strength training apparatuses according to the first Variant and the second Variant of Example 6, Example 7, Example 8, and Example 9, which possess unfixed rotatable shaft, the orbit of the movement of the mobile region becomes free. For this reason, various muscle strength training which mobilizes muscles of upper extremity, body truck, and lower extremity separately or simultaneously can be performed only by one apparatus by carrying out performance to the daily performance. Concrete examples of the method for muscle strength training will be cited.

### <Following Muscle Strength Training at Face-Up Position, Long Sitting Position, Seated Position, and Standing Position>

### Partial Training and Whole Body Training

High Load Muscle Strength Training Together with Low Load Aerobic Exercise

### At Face-Up Position

Bending and Stretching Lower Extremity Joints (Crotch, Knee, and Foot), Shoulder Press/Pull, Elbow Flexion/Extension

### At Long Sitting Position

Bending and Stretching Lower Extremity Joints (Crotch, Knee, and Foot), Shoulder Press/Pull, Chest Press/Pull, Elbow Flexion/Extension, Abdominal/Ab Back, Rowing

### At Seated Position

Leg Curl/Extension, Shoulder Press/Pull, Chest Press/Pull, Elbow Flexion/Extension, Abdominal/Ab Back, Rowing

### At Standing Position

Squat, Deadlift, Bent-over Row (Press/Pull), Side Bent (Press/Pull), Chest Press/Pull, Elbow Flexion/Extension, Rowing, Rowing Japanese Boat

A measurement gauge for measuring distortion (for example, distortion gauge) may be equipped with the muscle strength training apparatuses of Examples 1 to 9 to output the detected value to a recording device. This makes it possible to record the load of training with time. The recorded data can be used for data processing, such as computerized for comparison with the training plan, to be used for health management.

For example, a distortion gauge is adhered onto the board part 4 or 5 of the first fitted part 1 or the board part 14 or 15 of the second fitted part 2 of the muscle strength training apparatus of Example 1 shown in FIG. 2, and is connected to a device for measuring a resistant value (not shown). When this apparatus for muscle strength training is used, the load against the board part 4 or 5 or the board part 14 or 15 can be measured and recorded by the change in the resistant values. For this reason, the data can be used for the health management.

If a communication function is provided in addition to the measurement gauge, the apparatus can be used for the health management from a local site utilizing a network. For example, the measured record is transmitted to a local site through a wireless transmitter to carry out health management of a person at home or an astronaut by a local host computer or by monitoring a specialist at a local site. For this reason, in the fields of high quality “preventive health management”, “management of chronic disease”, “independence support for the elderly” and the like, systems and service utilizing them can be coordinated in a seamless manner, making it possible to drastically improve the quality of personal healthcare.

The present invention is not restricted to Embodiments and Examples described above and includes various variants within a scope not departing from the claims and within a scope easily done by those skilled in the art.

### BRIEF DESCRIPTION OF THE DRAWINGS

FIG. 1 A side view of a muscle strength training apparatus of Example 1.

FIG. 2 A plane view of a muscle strength training apparatus of Example 1.

FIG. 3 A drawing showing the situation that the muscle strength training apparatus of Example 1 is applied in the sitting situation.

FIG. 4 A drawing showing the situation that the muscle strength training apparatus of Example 1 is applied and the knee is somewhat stretched.

FIG. 5 A drawing showing the situation that the muscle strength training apparatus of Example 1 is applied and the knee is entirely stretched.

FIG. 6 A drawing showing the situation that the muscle strength training apparatus of Example 2 is applied and the ankle bent.

FIG. 7 A drawing showing the situation that the muscle strength training apparatus of Example 2 is applied and the ankle stretched.

FIG. 8 A plane view of a muscle strength training apparatus of Example 2.

FIG. 9 A drawing showing the situation that the muscle strength training apparatus of Example 3 is applied and the knee is somewhat stretched.

FIG. 10 A plane view of a muscle strength training apparatus of Example 4.

FIG. 11 A plane view of a muscle strength training apparatus of Example 5.

FIG. 12 A plane view of a muscle strength training apparatus of Example 6, where the lever is spread.

FIG. 13 A plane view of a muscle strength training apparatus of Example 6, where the lever is held.

FIG. 14 A schematic view showing the use situation of a muscle strength training apparatus of the first Variant of Example 6.

FIG. 15 A schematic view showing the use situation of a muscle strength training apparatus of the second Variant of Example 6

FIG. 16 A plane view of a muscle strength training apparatus of Example 7, where the lever is held.

FIG. 17 A photo substituted for a drawing showing the use situation of a muscle strength training apparatus of Example 7.

FIG. 18 A plane view of a muscle strength training apparatus of Example 8.

FIG. 19 A plane view of a muscle strength training apparatus of Example 9.

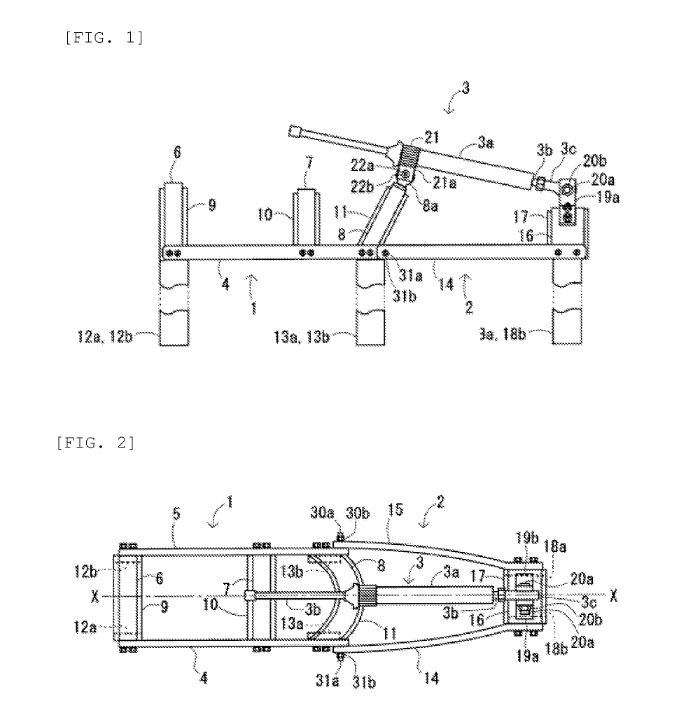

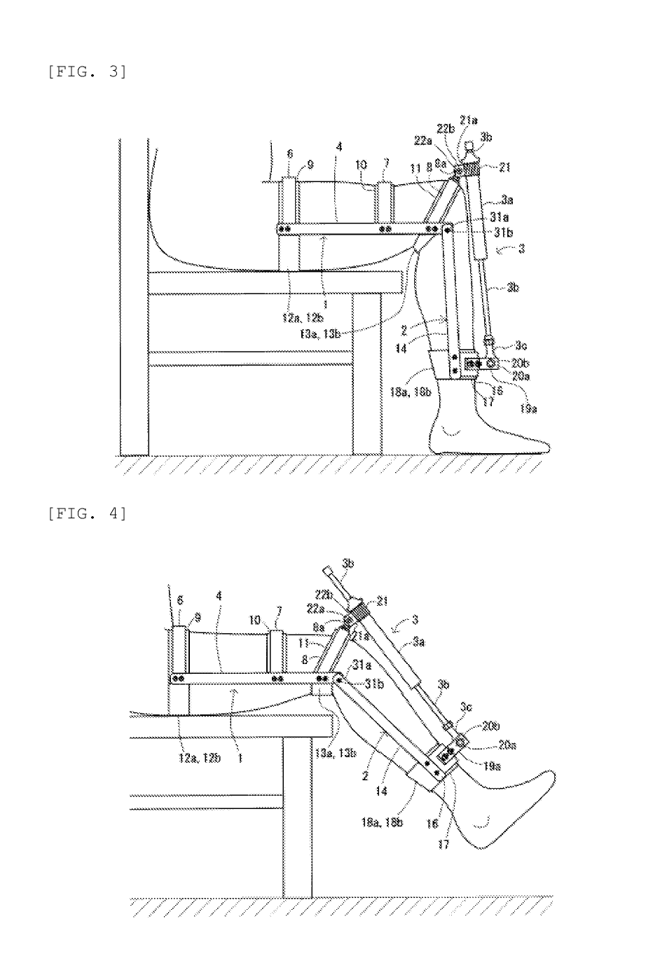

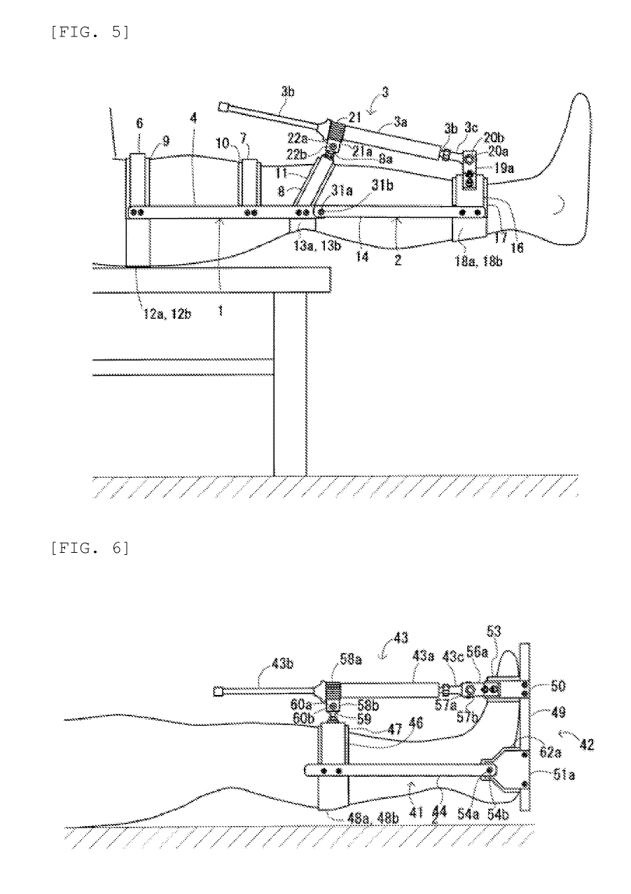

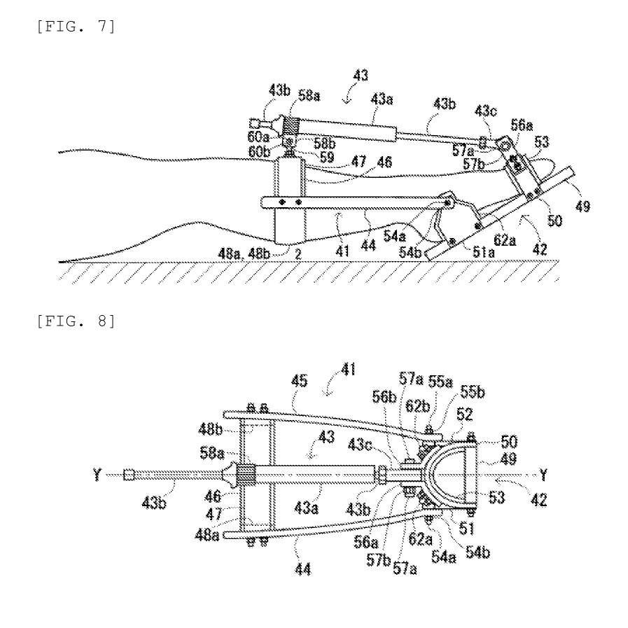

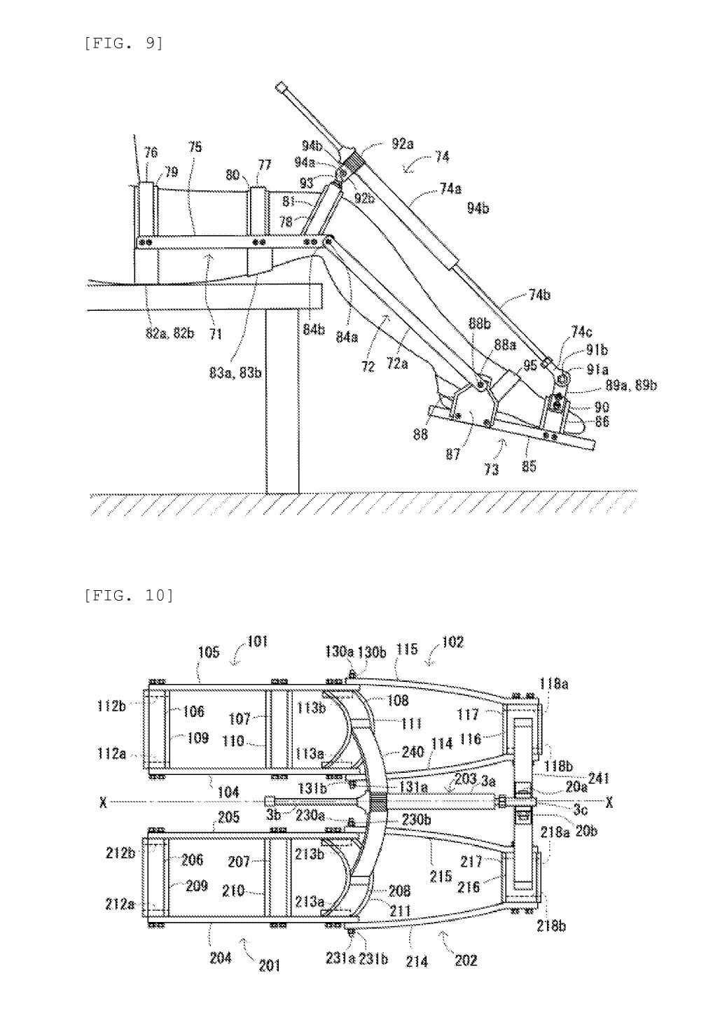

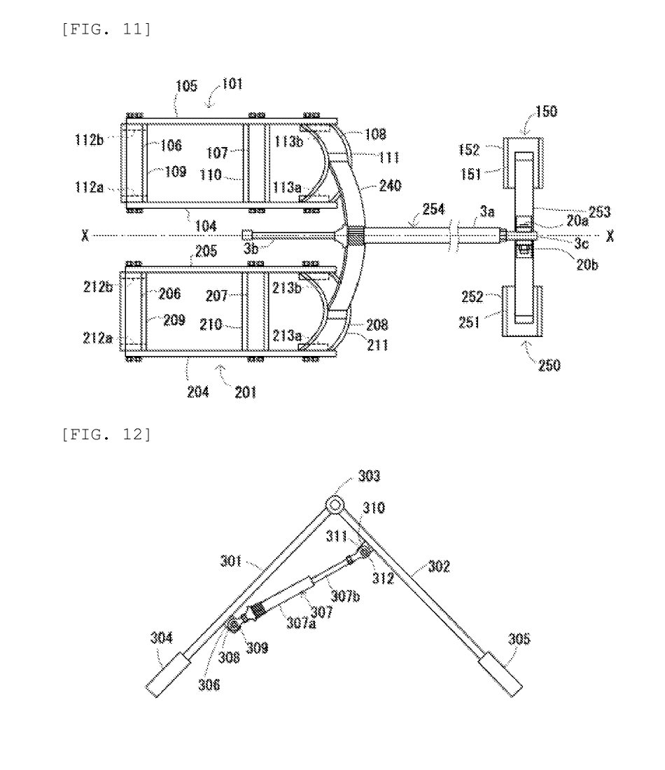

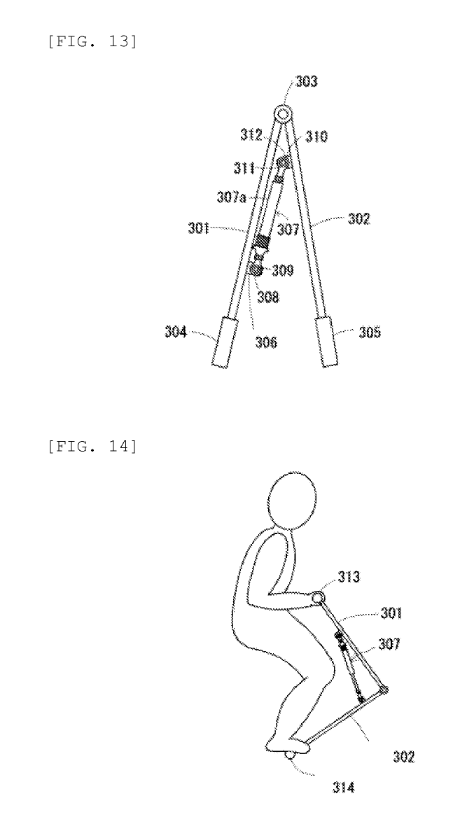

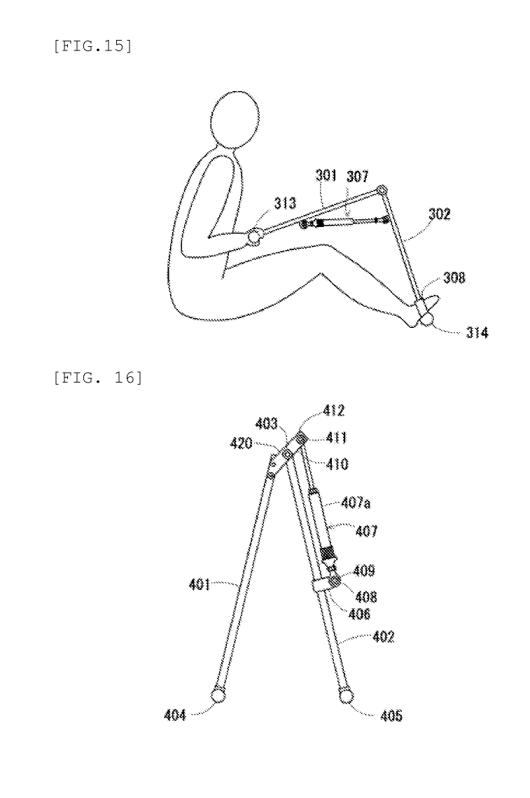

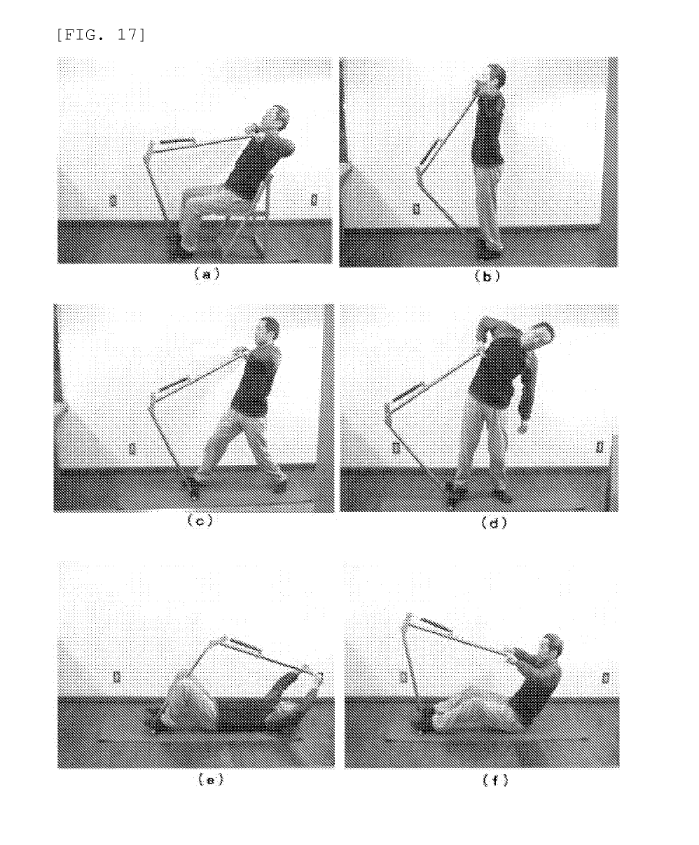

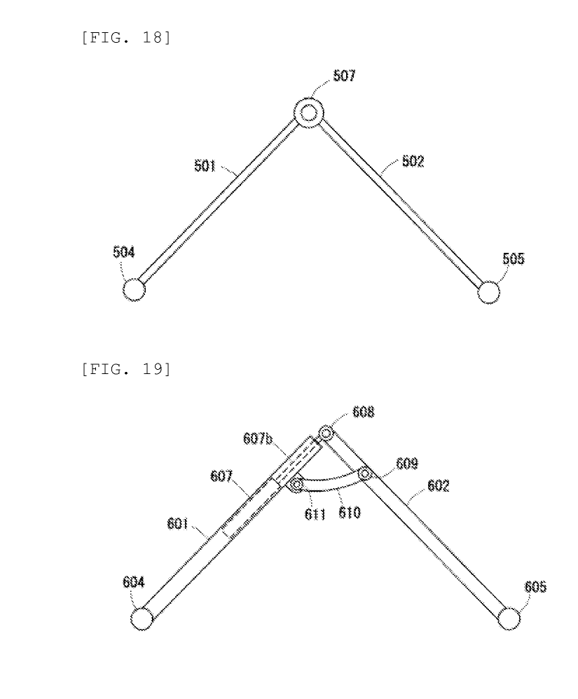

### INDUSTRIAL APPLICABILITY

In the muscle strength training apparatus according to the first to ninth aspects of the present invention, training can be performed depending upon the muscle strength, various persons irrespective of age or sex can be used. Also, in the muscle strength training apparatus according to the first to ninth aspects of the present invention, exercise is performed not using gravity force but using a resistance of the oil damper, training can be performed even in a non-gravity space platform. For this reason, the apparatus can also be used as an exercise apparatus for preventing musculoskeletal system disuse atrophy of an astronaut prolonged staying in the International Space Station.

1. A muscle strength training apparatus characterized in that one end of a first part and one end of a second part are movably supported by a bearing, and the first part and the second part are connected via an oil damper.

2. The muscle strength training apparatus as claimed in claim 1, wherein said first part and said second part make up a T-shape.

3. The muscle strength training apparatus as claimed in claim 1, wherein said first part is fitted along a region extending to a body side of the user from the elbow joint or the knee joint;
said second part is fitted along a region extending to the terminal side from the elbow joint or the knee joint of the user;
said first part and said second part are axially attached in a bending manner not so as to inhibit the movement of bending and stretching the knee joint or the elbow joint, the oil damper is positioned opposite the side where the upper extremity or the lower extremity is bent and stretched; and
the shaft center of the oil damper is positioned along the center line of upper extremity or the lower extremity in the width direction.

4. The muscle strength training apparatus as claimed in claim 3, wherein the resistance value of the oil damper is configured to be adjustable.

5. The muscle strength training apparatus as claimed in claim 3, wherein the oil damper is placed along the second part.

6. The muscle strength training apparatus as claimed in claim 1, wherein the first part is applied along a region of the user from the ankle to the shin,
the second part is applied along the bottom of the foot,
the first part and the second part are axially attached in a bendable manner not so as to inhibit bending and stretching movement of the ankle joint,
the oil damper is placed at the side where the ankle is bent and stretched, and
the shaft center of the oil damper is placed along the center line of the calf in the width direction.

7. The muscle strength training apparatus as claimed in claim 1,
which is an apparatus for training both the right and left lower extremities at the same time,
wherein said apparatus possesses a pair of the first parts applied to portions extending to a body side of the user from both knee joints, and a pair of the second parts applied to portions extending to the terminal side from the both knee joints of the user,
these first parts and the second parts are axially attached in a bending manner not so as to inhibit the movement of bending and stretching the knee joints,
the both first parts are connected by a first connector and the both second parts are connected by a second connector, and,
the first connector and the second connector are connected via the oil damper.

8. The muscle strength training apparatus as claimed in claim 1,
which is an apparatus for training both the right and left lower extremities at the same time,
wherein said apparatus possesses a pair of the first parts applied to portions extending to a body side of the user from the both knee joints, and a pair of the second parts applied to portions extending to the tip side from both ankles of the user,
these first parts and the second parts are axially attached in a bending manner not so as to inhibit the movement of bending and stretching the knee joints,
the both first parts are connected by a first connector and the second parts are connected by a second connector, and
the first connector and the second connector are connected via the oil damper.

9. An apparatus for training muscle strength of lower extremity,
having a first fitted part applied along a portion extending to a body side of the user from the both knee joints,
a second fitted part applied along a portion extending to the terminal side from the both knee joints of the user, and
a third fitted part applied to the bottom of the foot of the user,
wherein the first fitted part and the second fitted part are axially attached in a bending manner not so as to inhibit the movement of bending and stretching the knee joint;
the second fitted part and the third fitted part are axially attached in a bending manner not so as to inhibit the up-and-down movement of the toe,
the first fitted part and the third are connected via the oil damper,
the oil damper is placed at the side opposite the side where the lower extremity is bent and stretched, and
the shaft center of the oil damper is placed along the center line of the lower extremity in the width direction.

10. A method for muscle strength training, which comprises
utilizing the muscle strength training apparatus according to claim 1 to bend and stretch the oil damper whereby improve the muscle strength.
